(19) United States
(12) Patent Application Publication
(10) Pub. No.: US 2007/0173380 A1
(43) Pub. Date: Jul. 26, 2007

(54) Exercise, rehabilitation and mobilization device for paraplegic and motorically handicapped persons

(76) Inventors: Ya'akov Gabel, Beat Lehem Ha'glilit (IL); Adi Wolfenfeld, Haifa (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 10/598,231

(22) PCT Filed: Jun. 16, 2005
(86) PCT No.: PCT/IL05/00639

§ 371 Date: Aug. 22, 2006

(30) Foreign Application Priority Data
Jun. 17, 2004 (IL) 162582

(51) Int. Cl. A63B 22/04; A63B 22/06

(52) U.S. Cl. 482/52; 482/57

(57) ABSTRACT

Presented herein is a novel exercise and mobilization device for paraplegic and motorically disabled people that enables the user to shift from a seated to an upright position and perform passive and active walking exercises, comprising a horizontal frame situated on wheels, a vertical frame, a mechanism to move the frame members between a seated and an upright position, a saddle shaped seating area, including a back and arm rest and pelvic and shoulder straps, which fully supports the user, a control panel providing the user full control of the device, and a removable foothold component that fastens to the user's feet and moves along a track mounted on the horizontal frame, which allows the user to practice walking-like motions, either passively or actively according to individual need and ability.

### BACKGROUND

The present invention relates in general to devices that enable paraplegic and motorically handicapped people to perform exercises, and more specifically to devices that enable paraplegic and motorically handicapped people to perform passive and active walking exercises for rehabilitation and mobilization purposes.

It is a well known fact that performing walking exercises in an upright, standing position is an essential part of the rehabilitation process of paraplegic, spinal, and leg injury patients. In addition to restoring partial and full walking abilities, passive and active walking exercises are important for the circulatory condition of the patient, preventing spasticity and restoring muscular functionality to the legs and torso.

Known in the art are several devices designed to provide a solution for this need. Most commonly known is the moving belt exercising apparatus, wherein walking is made possible for the patient by full or partial weight relief and by additional guidance of the legs provided by physiotherapists. This apparatus is only suited for patients whose circulatory condition enables them to remain in an upright position for substantial periods of time, and who are already able to perform partially active walking exercises.

Several devices were designed to overcome these constraints. U.S. Pat. No. 6,685,658, for example, describes an apparatus that actively moves the legs of a disabled person in a movement pattern that is similar to physiological walking. This apparatus is designed to aid patients in their initial stages of rehabilitation and enables performing only passive walking exercises.

There are several shortcomings to this apparatus, which are also shared with other existing solutions: first, existing devices provide a solution to a particular stage of the therapeutic process—they are designed to allow either passive or active exercises but not both; second, the harnessing and patient bodyweight supporting methods of these devices are very often cumbersome or very inconvenient; third, these devices may not be fully operated by the patient both in passive and in active modes as they do not enable the patients to passively or actively mobilize themselves, and finally, these devices, which are usually big and expensive, may only be found in rehabilitation institutes and are not suited for long-term home use.

There is therefore a need for a simple, low-cost, passive and active walking exercise and rehabilitation device with a comfortable harnessing solution, which may be fully operated by the patients and may also allow them to mobilize themselves within their surroundings.

### SUMMARY

It is the objective of the present invention to provide a novel device that addresses the above described shortcomings. This is achieved by providing a unique exercise and mobilization device for paraplegic and motorically disabled people, which enables the user to shift from a seated position to an upright position as well as to perform passive and active walking exercises

The novel invention presented herein comprises a horizontal frame member that is situated on wheels, a vertical frame member that is supported and operated by a mechanism that enables the frame members to move between a seated position and an upright position, a seating area mounted on the vertical frame, including a back and arm rest, that fully supports the user, and a control panel that allows the user to fully control the device.

The saddle shaped seat further includes attached pelvic and shoulder straps that securing the position of the user within the seat and provide stability to the user. This unique seat design includes special support shaped to fit the user's underside.

Also unique to the present invention is the removable foothold component that can be fastened to the user's feet. These footholds move along a track mounted on the horizontal frame, allowing the user to practice a walking-like motion along the track while supported in an upright position. The movement of the feet within the footholds may be either passive or active according to the needs and abilities of the user.

The device may be further controlled by a control panel that is located behind the seat, which allows a second person, such as a therapist or a caregiver to control the device. There is also an option for operating the device by means of voice activation commands.

### BRIEF DESCRIPTION OF THE DRAWINGS

The above, as well as other advantages of the present invention will become readily apparent to those skilled in the art from the following detailed description of a preferred embodiment when considered in the light of the accompanying drawings in which:

FIG. 1 is a schematic illustration of the device in a seated position in accordance with the present invention;

FIG. 2 is a schematic illustration of the device in an upright position in accordance with the present invention;

FIG. 3 is a detailed illustration of the device in an upright position in accordance with the present invention;

FIG. 4 is a detailed illustration of the device in an upright position without the leg motion generator apparatus in accordance to the present invention;

FIG. 4a is an illustration of the dismantled leg motion generator apparatus;

FIG. 5 is a detailed illustration of the arm rest and control panel of the device in accordance with the present invention;

FIG. 6 is a detailed illustration of the saddle seat and supporting straps of the device in accordance with the present invention.

### DETAILED DESCRIPTION OF THE PREFERRED EMBODIMENT

The present invention is an exercise and mobilization device for paraplegic and motorically disabled people, which can be fully self-operated by the user. The device enables the user to change from a seated position to an upright position, perform passive and active walking exercises, and passively or actively mobilize the device. The design of the device overcomes many of the shortcomings of prior art regarding harnessing and bodyweight supporting solutions and ease of use, and may easily be adjusted to suit different needs and levels of user ability. In addition, the disclosed device is lightweight, and relatively small and potentially low cost and therefore may be suited for home as well as institutional use.

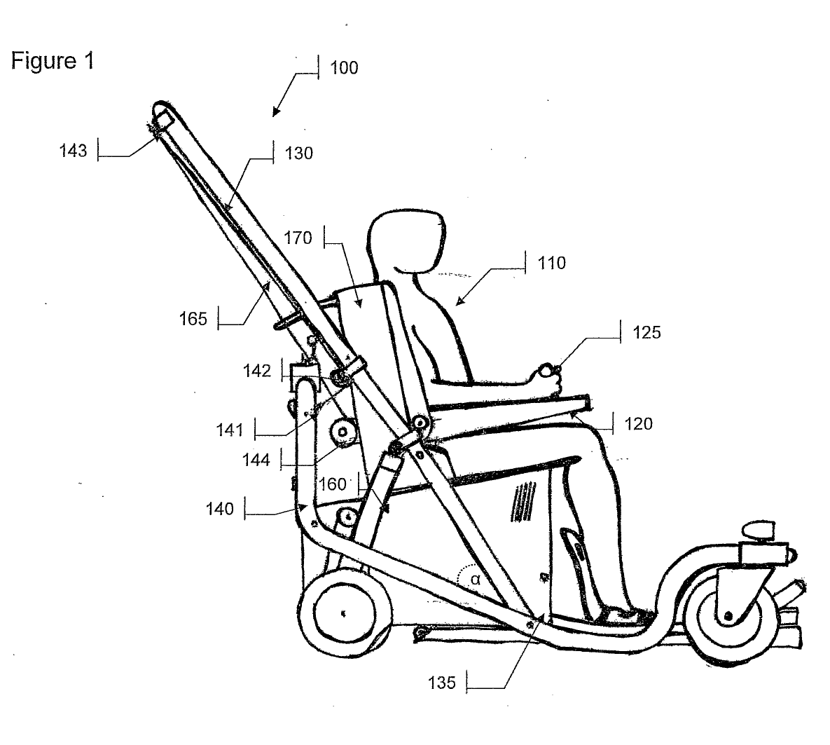

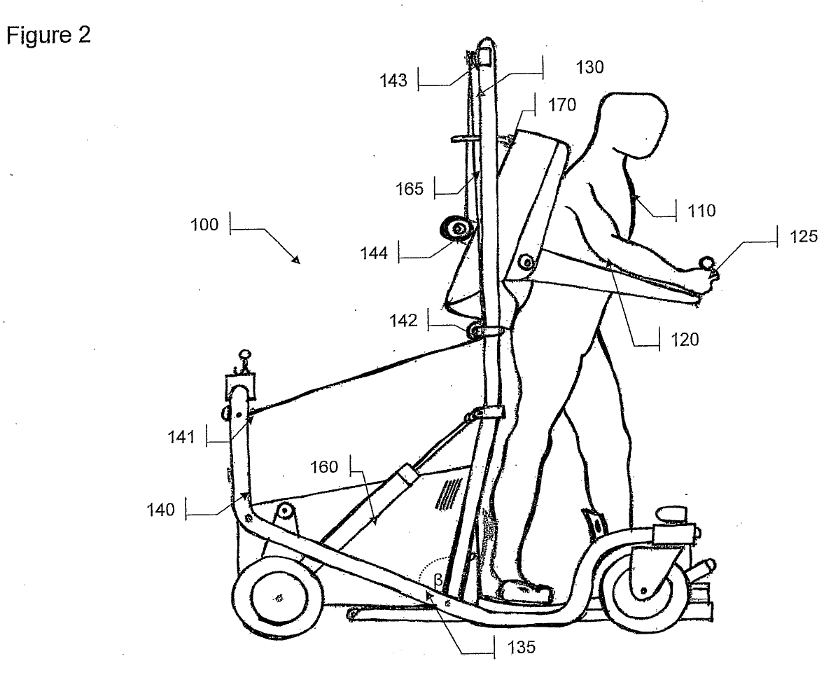

FIG. 1 and FIG. 2 illustrate the device 100 in its two basic positions: the seated position (FIG. 1) and the upright standing position (FIG. 2). Once seated in the device 100, user 110 may operate the device 100 to shift from the seated position to the upright position by pressing a button, by using voice commands, or by using a joystick on the user control panel 125, which is situated on the arm rest 120. The user control panel 125 activates pistons 160, located on both sides of the device. (Note that for the purposes of this document, a “piston” is defined as any movable cylinder that slides back and forth within a slightly larger, cylindrical chamber with a closed head.) As pistons 160 extend, they push the vertical frame 130 away from the horizontal frame 140. The two frames are connected at axis 135 and therefore, as the pistons 160 extend, acute angle α (see FIG. 1), located between the vertical frame 130 and the horizontal frame 140, increases to a nearly right angle β (see FIG. 2). In other embodiments, other methods of moving vertical frame 130 away from the horizontal frame 140 may be employed. In different embodiments of the invention, the pistons 160 may be driven by an electrical motor or a hydraulic mechanism.

Cable 165 is stretched between pin 141, to pulleys 142 and 143, and then to motor 144. As the vertical frame 130 is pushed up, the distance between it and pin 141 increases. The segment of cable 165 between pin 141 and pulley 142 expands, causing the distance between pulley 143 and motor 144 to decrease, and pulling up pulley 143, which causes the saddle seat 170, as well as the user 110 seated upon seat 170, to rise with it. As the vertical frame 130 reaches its upright position, the seat 170 is raised to support the user at the appropriate height (see FIG. 2). This is a slow and gradual motion that can be fully controlled by the user. Motor 144 is used to adjust the height of saddle seat 170 in the standing position to the height of the user. Similarly, lowering the device back to its initial seated position is performed by contracting the length of pistons 160. In this case, the combined weight of the saddle seat 170 and the user 110 seated upon seat 170 causes the saddle seat 170 to return to its initial position.

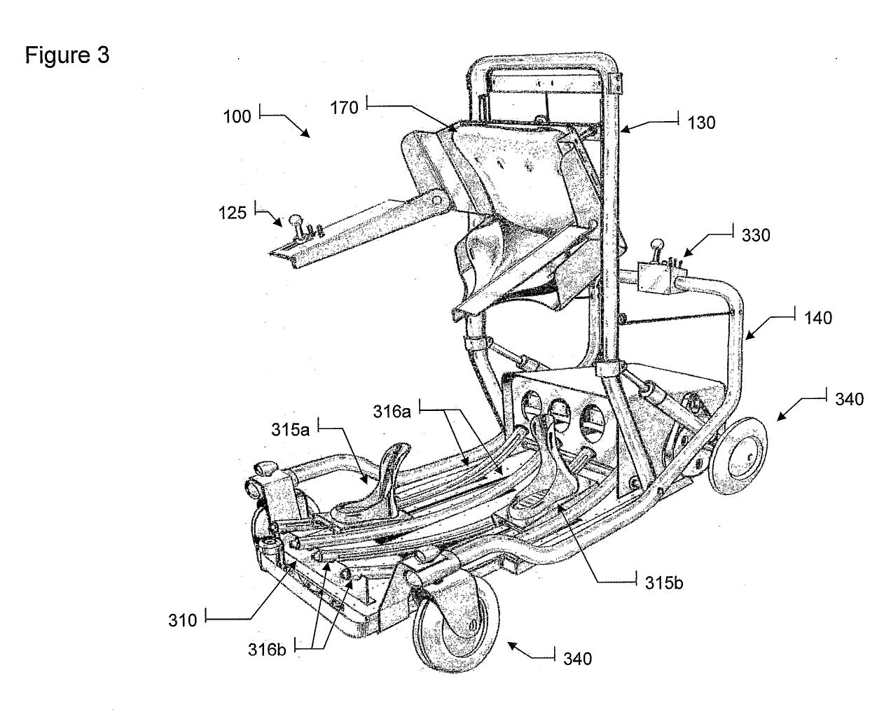

FIG. 3 is a fully detailed illustration of a frontal view of the device in the upright position. This figure clearly depicts the footholds 315a, 315b, the tracks 316a, 316b, and the leg motion generator apparatus 310. The footholds 315a, 315b are fastened to the user's feet in order to hold the feet in place and to allow a walking-like motion along the arched tracks 316a, 316b. While the device is in the seated position or in transition between the seated position and the upright, standing position, the footholds 315a, 315b are secured in the center of tracks 316, allowing a natural 90° sitting position (see FIG. 1). Once the user is in the upright position, he or she may passively or actively perform walk exercises as their body is safely held in place. In the passive exercise mode, which is designed for paraplegic patients, the device performs the back and forth motion of the feet along the tracks 316. The shape of the tracks 316 and the motion produced by the device are designed to fully emulate a normal, walking-like motion. In the active exercise mode, the footholds are free to be moved back and forth along the tracks 316 by the users, while the users' bodyweight is carried by the saddle seat 170. The mode of exercise and the speed and stride of the foothold motion, which may be fully controlled by the user via the user control panel 125, is produced by motor 320, which is situated at the far end of the tracks 316.

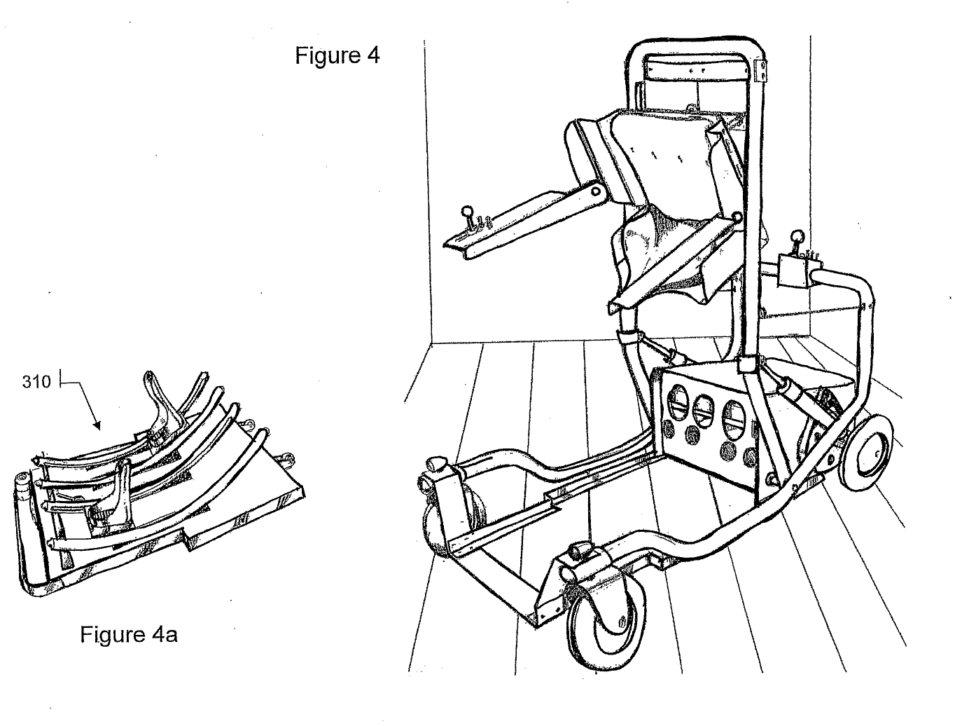

As illustrated in FIG. 4 and FIG. 4a, the leg motion generator apparatus 310 may be disconnected from the device 100. This allows users to exercise while standing and walking directly on the floor, while the device gives them balance and helps support their bodyweight. In this configuration, the device operates as a supportive walking frame or as a walker.

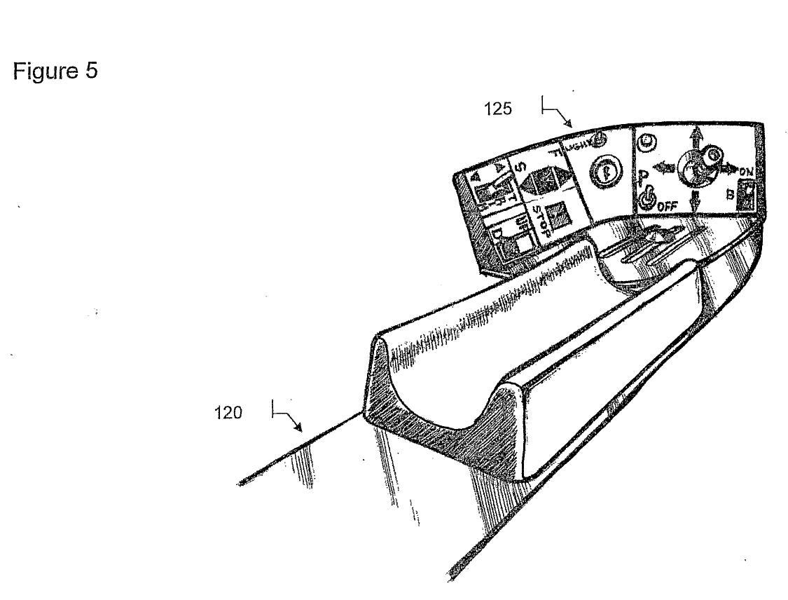

The user control panel 125 is illustrated in FIG. 5. It is situated within reach of the hand, at the far end of the arm rest 120. In addition to allowing the user to turn the device on and off, change the seated position of the device to the upright position, and control the foothold apparatus mode of operation, the user control panel 125 also enables the user to control and steer the motion of the device itself. As FIGS. 1 to 3 show, the device is situated on four wheels 340 that allow the device to be mobilized. This allows the device to operate as an electric wheelchair, in both the seated and the upright positions. The user control panel 125 also allows the user to lock the wheels of the device 340 in order to avoid undesirable movements during exercise or, on the other hand, to release the wheels so that the device may be moved around freely. Releasing the wheels is especially useful when the device is without the leg motion generator apparatus 310 and is used as a supporting walking frame. An additional control panel 330 is situated at the back of the device (see FIG. 3), allowing a therapist or a caregiver to control the operation of the device.

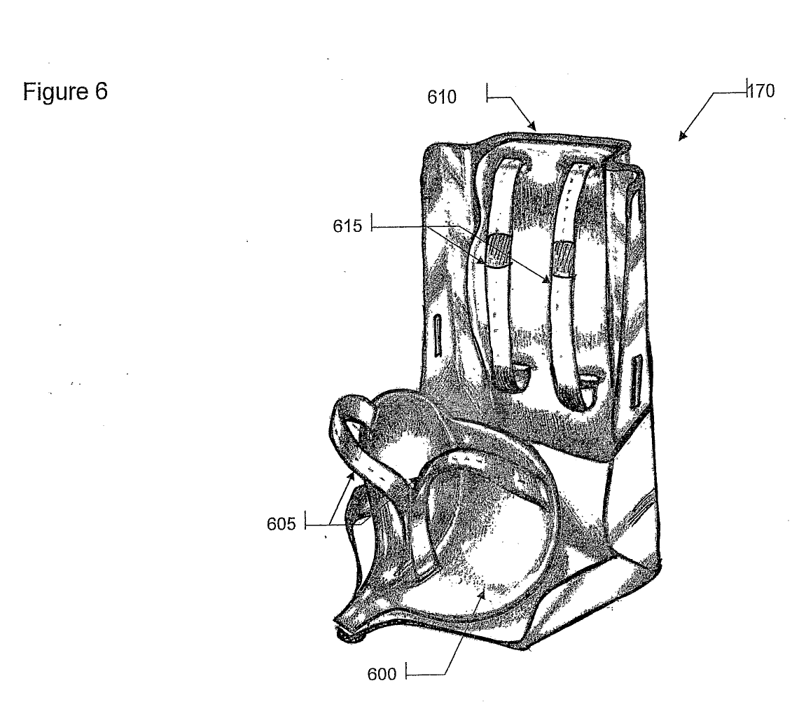

The unique structure of the saddle seat 170 is illustrated in FIG. 6. It comprises a saddle-like seat area 600 with two pelvic straps 605 and two shoulder straps 615 attached to the back support 610. The saddle seat area 600 is especially designed to provide full support to the bodyweight of the user, both in the seated and in the standing positions. It supports the user's body by providing support to the buttocks, bones, and pelvic area from behind and from below. This design overcomes the shortcomings of prior art strapping and supporting solutions, which cause major discomfort, especially in the standing position. The design allows most of the weight of the user in the standing position to be carried by the seat itself, and not by the straps. The main function of pelvic straps 605 and the shoulder straps 615 is to insure that the user is safely positioned in the seat. The user does not carry his weight and thus does not apply any unnecessary pressure to the body.

It should be clear that the description of the embodiments and attached figures set forth in this specification serve only for a better understanding of the invention, without limiting its scope as covered by the following claims.

It should also be clear that a person skilled in the art, after reading the present specification, could make adjustments or amendments to the attached figures and above described embodiments, which would still be covered by the following claims.

What is claimed is:

1. An exercise and mobilization device for paraplegic and motorically disabled people, enabling the user to shift from a sitting to an upright position and perform passive and active walking exercises, said device comprised of
a construction of a horizontal frame assembled with a vertical frame wherein the horizontal frame is situated on wheels and the vertical frame is supported and operated via an mechanical mechanism enabling said frame to move between a seated position and an upright position;
a seat including a back and arm rest mounted on said vertical frame wherein said seat supports the user when shifting between a seated and upright position;
a control panel located on the arm rest, enabling the user to control all device functions;
pulleys positioned on the vertical frame, wherein a cable is stretched between said pulleys and the horizontal frame for controlling the saddle seat position when shifting between a seated position and upright position;

2. The device of claim 1 wherein the seat takes the form of a saddle seat and includes a special supporting design shaped to fit the user's underside.

3. The device of claim 1 further comprising a control panel behind the seat enabling a second person to control the device.

4. The device of claim 1 further comprising means for operating the device by voice activation commands;

5. The device of claim 1 wherein the wheels supporting the horizontal frame are electrically driven.

6. The device of claim 1 further comprising footholds that are fastened to the user's feet, said footholds being movable along a track mounted on the horizontal frame, enabling the user to practice a walking-like motion along the track while in the upright position;

7. The device of claim 1, wherein the control panel provides the control of movement between a seated position and upright position

8. The device of claim 1 further comprising an electric motor for adjusting the height of the seat when the device is in the upright position;

9. The method of claim 1 further comprising pelvic and shoulder straps that are attached to the saddle seat for stabilizing and securing the position of the user within the saddle seat.

10. The method of claim 1, wherein the mechanism is an electrically activated piston.

11. The method of claim 1, wherein the mechanical mechanism is a hydraulically activated piston.
